(19) United States
(12) Patent Application Publication
(10) Pub. No.: US 2012/0172551 A1
(43) Pub. Date: Jul. 5, 2012

(54) SOLID CATALYST FOR PROPYLENE POLYMERIZATION AND A METHOD FOR PREPARATION OF POLYPROPYLENE USING THE SAME

(75) Inventors: Sang Yull KIM, Chungcheongnam-do (KR); Jin Woo LEE, Chungcheongnam-do (KR); Eun Il KIM, Daejeon (KR); Joon Ryeo PARK, Seoul (KR)

(73) Assignee: SAMSUNG TOTAL PETROCHEMICALS CO., LTD., Chungcheongnam-do (KR)

(21) Appl. No.: 13/296,681

(22) Filed: Nov. 15, 2011

(30) Foreign Application Priority Data
Jan. 5, 2011 (KR) 10-2011-0001030

(51) Int. Cl. C08F 4/76; C08F 10/06; C08F 2/00

(52) U.S. Cl. 526/125.3; 556/40

(57) ABSTRACT

A solid catalyst for propylene polymerization includes titanium, magnesium, halogen and a maleate compound as an internal electron donor. A method for preparing propylene using the catalyst is also described. According to the present invention, it is possible to prepare polypropylene having a wide molecular weight distribution.

### TECHNICAL FIELD

The present invention is directed to a solid catalyst for propylene polymerization, which comprises titanium, magnesium, halogen and a maleate compound as an internal electron donor, and a method for preparing polypropylene using the same.

### BACKGROUND OF THE INVENTION

Polypropylene has various industrial applications, particularly it is widely applied for materials used in automobiles and electronic products, etc. with various usages. For more expanded applications of polypropylene, an improvement in rigidity which may be led by an increase in the degree of cristallinity is further required as well as a wide molecular weight distribution so as to have improved processability. In order to obtain such properties in polypropylene, it is needed for a solid catalyst for preparing the same to be designed to provide a polymer having high stereoregularity and wide molecular weight distribution.

For polymerization of olefins such as propylene or the like, a solid catalyst comprising magnesium, titanium, an electron donor and halogen as essential elements is known in this field of art, and many methods for polymerizing or copolymerizing olefins have been proposed. However, such methods are not satisfying in terms of obtaining polymers having high stereoregularity with high production yield, and thus needed to be improved in the above aspect.

In order to reduce the production cost by increasing the polymerization activity and improve physical properties of the resulted polymers by improving the catalyst performance such as stereoregularity, it is generally known in this field of art to use diester of aromatic dicarboxylic acid as an internal electron donor and related patent applications have been filed many, for examples, U.S. Pat. No. 4,562,173, U.S. Pat. No. 4,981,930, Korean Patent No. 0072844 and the like. The above patents describe a method for preparing a catalyst showing high activity and stereoregularity by using aromatic dialkyldiesters or aromatic monoalkylmonoesters. However, the methods according to the above-mentioned patents cannot provide high stereoregular polymers with high yield to satisfying degree and thus further improvements in the methods are needed. There have been many efforts to broaden the molecular weight distribution of a polymer. For example, U.S. Pat. No. 6,376,628 suggests a method for broadening the molecular weight distribution by polymerizaing propylene at the presence of a solid catalyst component comprised of magnesium, titanium, halogen and an electron donor, an organoaluminum compound and an isoquinoline silicon compound, however it still needs to be further improved in terms of catalyst activity and flowability. Korean patent No. 0491387 discloses a method for preparing a catalyst using a non-aromatic compound having both ketone and ether group therein as an internal electron donor. However, the methods of said two patents are still needed to be further improved in terms of activity and stereoregularity.

Additionally, U.S. Pat. No. 7,015,170 suggests a catalyst preparation method which uses maleates having a substitution group only at the second carbon as an internal electron donor, however stereoregularity and molecular weight distribution of a polymer prepared using the catalyst still need to be significantly improved.

### SUMMARY OF THE INVENTION

The present invention has now been developed to solve the above problems of prior arts. Therefore, the purpose of the present invention is to provide a solid catalyst for preparing polypropylene having excellent stereoregularity and wide molecular weight distribution by using a specific maleate compound as an internal electron donor, and a method for preparing polypropyelen using the catalyst.

### DETAILED DESCRIPTION OF THE INVENTION

In order to achieve the purpose of the present invention, the solid catalyst for propylene polymerization according to the present invention is characterized by comprising titanium, magnesium, halogen and maleate compound represented by the following formula (II) as an internal electron donor:

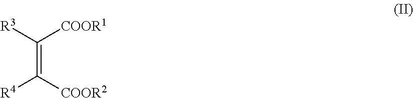

wherein, R¹, R², R³ and R⁴, which may be same or different, are independently linear, branched or cyclic C1-20 alkyl, alkenyl, aryl, arylalkyl or alkylaryl group.

The solid catalyst according to the present invention may be preferably prepared by a method comprising the following steps:

(1) reacting dialkoxy magnesium with titanium halide in the presence of an organic solvent;
(2) adding a maleate internal electron donor having the above formula (II) to the product resulted from the above step (1) and reacting them together, with increasing the temperature to the range of 60-150° C.; and
(3) reacting the product obtained from the above step (2) with titanium halide at the temperature of 0-150° C. and washing the resulted product.

Although the organic solvent used in the above step (1) is not specifically limited, preferably used may be C6-12 aliphatic, aromatic or halogenated hydrocarbons, more preferably C7-10 saturated aliphatic, aromatic or halogenated hydrocarbons, and for example, at least one selected from the group consisting of octane, nonane, decane, toluene, xylene, chlorobutane, chlorohexane, chloroheptane and the like may be used alone or as a mixture. The dialkoxymagnesium used in the above step (1) which is obtained by reacting metal magnesium with an alcohol anhydride in the presence of magnesium dichloride is spherical particles having an average particle diameter of 10-200 μm with a smooth surface, and the spherical particle shape is preferably remained as it is even during propylene polymerization. When the average particle diameter is less than 10 μm, an increased amount of microparticles are present in the resulted catalysts and when it is more than 200 μm, bulk density of the resulted carrier is likely to be smaller, disadvantageously. As for the dialkoxymagnesium, particularly diethoxymagnesium is preferred.

Alkoxymagnesium halide, magnesium alkyl carbonate such as magnesium ethyl carbonate, magnesium dichloride in the form of solid or solution may be used in the above step (1) other than dialkoxymagnesium.

The ratio of the organic solvent to dialkoxymagnesium, i.e. dialkoxymagnesium(weight): organic solvent(volume) is preferably 1:5-50, more preferably 1:7-20. When the ratio is less than 1:5, viscosity of the slurry becomes rapidly increased thereby hindering homogeneous stirring, and when it is more than 1:50, the bulk density of the resulted carrier is significantly reduced or the particle surface becomes rough, disadvantageously.

The titanium halides used in the above step (1) of the process for preparing a solid catalyst according to the present invention may be preferably represented as the following formula (I):

Ti(OR)ₐX₍₄₋ₐ₎ (I)

wherein, R is a C1-10 alkyl group; X is halogen atom; a is an integer of 0-3 for the atomic valence in the above formula (I). Particularly, titanium tetrachloride is preferably used.

The step (1) of the process for preparing a solid catalyst is preferably carried out by gradually adding titanium halide to dialkoxymanesium suspended in an organic solvent at a temperature range of −20° C.-50° C.

The amount of titanium halide used in the above step (1) is preferably 0.1-10 moles, more preferably 0.3-2 moles, based on 1 mole of dialkoxymagnesium. When the amount is less than 0.1 mole, the conversion of dialkoxymagnesium to magnesdium chloride does not smoothly proceed, and when the amount is more than 10 moles, an excessive amount of titanium components are present in the resulted catalyst, disadvantageously.

The specific examples of the maleate internal electron donors having a formula (II) which may be used in the above step (2) include the following compounds, alone or as a mixture of 2 or more selected therefrom: dimethyl 2,3-dimethylmaleate, dimethyl 2-methyl-3-ethylmaleate, dimethyl 2-methyl-3-propylmaleate, dimethyl 2-methyl-3-butylmaleate, dimethyl 2-methyl-3-pentylmaleate, dimethyl 2-methyl-3-hexylmaleate, dimethyl 2-methyl-3-octylmaleate, dimethyl 2-methyl-3-heptylmaleate, dimethyl 2-methyl-3-decylmaleate, dimethyl 2-methyl-3-isopropylmaleate, dimethyl 2-methyl-3-isobutylmaleate, dimethyl 2-methyl-3-neopentylmaleate, dimethyl 2-methyl-3-cyclopentylmaleate, dimethyl 2-methyl-3-cyclohexylmaleate, dimethyl 2,3-diethylmaleate, dimethyl 2-ethyl-3-propylmaleate, dimethyl 2-ethyl-3-butylmaleate, dimethyl 2-ethyl-3-pentylmaleate, dimethyl 2-ethyl-3-hexylmaleate, dimethyl 2-ethyl-3-octylmaleate, dimethyl 2-ethyl-3-heptylmaleate, dimethyl 2-ethyl-3-decylmaleate, dimethyl 2-ethyl-3-isopropylmaleate, dimethyl 2-ethyl-3-isobutylmaleate, dimethyl 2-ethyl-3-neopentylmaleate, dimethyl 2-ethyl-3-cyclopentylmaleate, dimethyl 2-ethyl-3-cyclohexylmaleate, dimethyl 2,3-dipropylmaleate, dimethyl 2-propyl-3-butylmaleate, dimethyl 2-propyl-3-pentylmaleate, dimethyl 2-propyl-3-hexylmaleate, dimethyl 2-propyl-3-octylmaleate, dimethyl 2-propyl-3-heptylmaleate, dimethyl 2-propyl-3-decylmaleate, dimethyl 2-propyl-3-isopropylmaleate, dimethyl 2-propyl-3-isobutylmaleate, dimethyl 2-propyl-3-neopentylmaleate, dimethyl 2-propyl-3-cyclopentylmaleate, dimethyl 2-propyl-3-cyclohexylmaleate, dimethyl 2,3-dibutylmaleate, dimethyl 2-butyl-3-pentylmaleate, dimethyl 2-butyl-3-hexylmaleate, dimethyl 2-butyl-3-octylmaleate, dimethyl 2-butyl-3-heptylmaleate, dimethyl 2-butyl-3-decylmaleate, dimethyl 2-butyl-3-isopropylmaleate, dimethyl 2-butyl-3-isobutylmaleate, dimethyl 2-butyl-3-neopentylmaleate, dimethyl 2-butyl-3-cyclopentylmaleate, dimethyl 2-butyl-3-cyclohexylmaleate, dimethyl 2,3-dipentylmaleate, dimethyl 2-pentyl-3-hexylmaleate, dimethyl 2-pentyl-3-octylmaleate, dimethyl 2-pentyl-3-heptylmaleate, dimethyl 2-pentyl-3-decylmaleate, dimethyl 2-pentyl-3-isopropylmaleate, dimethyl 2-pentyl-3-isobutylmaleate, dimethyl 2-pentyl-3-neopentylmaleate, dimethyl 2-pentyl-3-cyclopentylmaleate, dimethyl 2-pentyl-3-cyclohexylmaleate, dimethyl 2,3-dihexylmaleate, dimethyl 2-hexyl-3-octylmaleate, dimethyl 2-hexyl-3-heptylmaleate, dimethyl 2-hexyl-3-decylmaleate, dimethyl 2-hexyl-3-isopropylmaleate, dimethyl 2-hexyl-3-isobutylmaleate, dimethyl 2-hexyl-3-neopentylmaleate, dimethyl 2-hexyl-3-cyclopentylmaleate, dimethyl 2-hexyl-3-cyclohexylmaleate, dimethyl 2,3-dioctylmaleate, dimethyl 2-octyl-3-heptylmaleate, dimethyl 2-octyl-3-decylmaleate, dimethyl 2-octyl-3-isopropylmaleate, dimethyl 2-octyl-3-isobutylmaleate, dimethyl 2-octyl-3-neopentylmaleate, dimethyl 2-octyl-3-cyclopentylmaleate, dimethyl 2-octyl-3-cyclohexylmaleate, dimethyl 2,3-didecyllmaleate, dimethyl 2-decyl-3-isopropylmaleate, dimethyl 2-decyl-3-isobutylmaleate, dimethyl 2-decyl-3-neopentylmaleate, dimethyl 2-decyl-3-cyclopentylmaleate, dimethyl 2-decyl-3-cyclohexylmaleate, dimethyl 2,3-diisopropylmaleate, dimethyl 2-isopropyl-3-isobutylmaleate, dimethyl 2-isopropyl-3-neopentylmaleate, dimethyl 2-isopropyl-3-cyclopentylmaleate, dimethyl 2-isopropyl-3-cyclohexylmaleate, dimethyl 2,3-diisobutylmaleate, dimethyl 2-isobutyl-3-neopentylmaleate, dimethyl 2-isobutyl-3-cyclopentylmaleate, dimethyl 2-isobutyl-3-cyclohexylmaleate, dimethyl 2,3-diisobutylmaleate, dimethyl 2-isobutyl-3-neopentylmaleate, dimethyl 2-isobutyl-3-cyclopentylmaleate, dimethyl 2-isobutyl-3-cyclohexylmaleate, dimethyl 2,3-dineopentylmaleate, dimethyl 2-neopentyl-3-cyclopentylmaleate, dimethyl 2-neopentyl-3-cyclohexylmaleate, dimethyl 2,3-dicyclopentylmaleate, dimethyl 2-cyclopentyl-3-cyclohexylmaleate, dimethyl 2,3-dicyclohexylmaleate, diethyl 2,3-dimethylmaleate, diethyl 2-methyl-3-ethylmaleate, diethyl 2-methyl-3-propylmaleate, diethyl 2-methyl-3-butylmaleate, diethyl 2-methyl-3-pentylmaleate, diethyl 2-methyl-3-hexylmaleate, diethyl 2-methyl-3-octylmaleate, diethyl 2-methyl-3-heptylmaleate, diethyl 2-methyl-3-decylmaleate, diethyl 2-methyl-3-isopropylmaleate, diethyl 2-methyl-3-isobutylmaleate, diethyl 2-methyl-3-neopentylmaleate, diethyl 2-methyl-3-cyclopentylmaleate, diethyl 2-methyl-3-cyclohexylmaleate, diethyl 2,3-diethylmaleate, diethyl 2-ethyl-3-propylmaleate, diethyl 2-ethyl-3-butylmaleate, diethyl 2-ethyl-3-pentylmaleate, diethyl 2-ethyl-3-hexylmaleate, diethyl 2-ethyl-3-octylmaleate, diethyl 2-ethyl-3-heptylmaleate, diethyl 2-ethyl-3-decylmaleate, diethyl 2-ethyl-3-isopropylmaleate, diethyl 2-ethyl-3-isobutylmaleate, diethyl 2-ethyl-3-neopentylmaleate, diethyl 2-ethyl-3-cyclopentylmaleate, diethyl 2-ethyl-3-cyclohexylmaleate, diethyl 2,3-dipropylmaleate, diethyl 2-propyl-3-butylmaleate, diethyl 2-propyl-3-pentylmaleate, diethyl 2-propyl-3-hexylmaleate, diethyl 2-propyl-3-octylmaleate, diethyl 2-propyl-3-heptylmaleate, diethyl 2-propyl-3-decylmaleate, diethyl 2-propyl-3-isopropylmaleate, diethyl 2-propyl-3-isobutylmaleate, diethyl 2-propyl-3-neopentylmaleate, diethyl 2-propyl-3-cyclopentylmaleate, diethyl 2-propyl-3-cyclohexylmaleate, diethyl 2,3-dibutylmaleate, diethyl 2-butyl-3-pentylmaleate, diethyl 2-butyl-3-hexylmaleate, diethyl 2-butyl-3-octylmaleate, diethyl 2-butyl-3-heptylmaleate, diethyl 2-butyl-3-decylmaleate, diethyl 2-butyl-3-isopropylmaleate, diethyl 2-butyl-3-isobutylmaleate, diethyl 2-butyl-3-neopentylmaleate, diethyl 2-butyl-3-cyclopentylmaleate, diethyl 2-butyl-3-cyclohexylmaleate, diethyl 2,3-dipentylmaleate, diethyl 2-pentyl-3-hexylmaleate, diethyl 2-pentyl-3-octylmaleate, diethyl 2-pentyl-3-heptylmaleate, diethyl 2-pentyl-3-decylmaleate, diethyl 2-pentyl-3-isopropylmaleate, diethyl 2-pentyl-3-isobutylmaleate, diethyl 2-pentyl-3-neopentylmaleate, diethyl 2-pentyl-3-cyclopentylmaleate, diethyl 2-pentyl-3-cyclohexylmaleate, diethyl 2,3-dihexylmaleate, diethyl 2-hexyl-3-octylmaleate, diethyl 2-hexyl-3-heptylmaleate, diethyl 2-hexyl-3-decylmaleate, diethyl 2-hexyl-3-isopropylmaleate, diethyl 2-hexyl-3-isobutylmaleate, diethyl 2-hexyl-3-neopentylmaleate, diethyl 2-hexyl-3-cyclopentylmaleate, diethyl 2-hexyl-3-cyclohexylmaleate, diethyl 2,3-dioctylmaleate, diethyl 2-octyl-3-heptylmaleate, diethyl 2-octyl-3-decylmaleate, diethyl 2-octyl-3-isopropylmaleate, diethyl 2-octyl-3-isobutylmaleate, diethyl 2-octyl-3-neopentylmaleate, diethyl 2-octyl-3-cyclopentylmaleate, diethyl 2-octyl-3-cyclohexylmaleate, diethyl 2,3-didecyllmaleate, diethyl 2-decyl-3-isopropylmaleate, diethyl 2-decyl-3-isobutylmaleate, diethyl 2-decyl-3-neopentylmaleate, diethyl 2-decyl-3-cyclopentylmaleate, diethyl 2-decyl-3-cyclohexylmaleate, diethyl 2,3-diisopropylmaleate, diethyl 2-isopropyl-3-isobutylmaleate, diethyl 2-isopropyl-3-neopentylmaleate, diethyl 2-isopropyl-3-cyclopentylmaleate, diethyl 2-isopropyl-3-cyclohexylmaleate, diethyl 2,3-diisobutylmaleate, diethyl 2-isobutyl-3-neopentylmaleate, diethyl 2-isobutyl-3-cyclopentylmaleate, diethyl 2-isobutyl-3-cyclohexylmaleate, diethyl 2,3-dineopentylmaleate, diethyl 2-neopentyl-3-cyclopentylmaleate, diethyl 2-neopentyl-3-cyclohexylmaleate, diethyl 2,3-dicyclopentylmaleate, diethyl 2-cyclopentyl-3-cyclohexylmaleate, diethyl 2,3-dicyclohexylmaleate, dipropyl 2,3-dimethylmaleate, dipropyl 2-methyl-3-ethylmaleate, dipropyl 2-methyl-3-propylmaleate, dipropyl 2-methyl-3-butylmaleate, dipropyl 2-methyl-3-pentylmaleate, dipropyl 2-methyl-3-hexylmaleate, dipropyl 2-methyl-3-octylmaleate, dipropyl 2-methyl-3-heptylmaleate, dipropyl 2-methyl-3-decylmaleate, dipropyl 2-methyl-3-isopropylmaleate, dipropyl 2-methyl-3-isobutylmaleate, dipropyl 2-methyl-3-neopentylmaleate, dipropyl 2-methyl-3-cyclopentylmaleate, dipropyl 2-methyl-3-cyclohexylmaleate, dipropyl 2,3-diethylmaleate, dipropyl 2-ethyl-3-propylmaleate, dipropyl 2-ethyl-3-butylmaleate, dipropyl 2-ethyl-3-pentylmaleate, dipropyl 2-ethyl-3-hexylmaleate, dipropyl 2-ethyl-3-octylmaleate, dipropyl 2-ethyl-3-heptylmaleate, dipropyl 2-ethyl-3-decylmaleate, dipropyl 2-ethyl-3-isopropylmaleate, dipropyl 2-ethyl-3-isobutylmaleate, dipropyl 2-ethyl-3-neopentylmaleate, dipropyl 2-ethyl-3-cyclopentylmaleate, dipropyl 2-ethyl-3-cyclohexylmaleate, dipropyl 2,3-dipropylmaleate, dipropyl 2-propyl-3-butylmaleate, dipropyl 2-propyl-3-pentylmaleate, dipropyl 2-propyl-3-hexylmaleate, dipropyl 2-propyl-3-octylmaleate, dipropyl 2-propyl-3-heptylmaleate, dipropyl 2-propyl-3-decylmaleate, dipropyl 2-propyl-3-isopropylmaleate, dipropyl 2-propyl-3-isobutylmaleate, dipropyl 2-propyl-3-neopentylmaleate, dipropyl 2-propyl-3-cyclopentylmaleate, dipropyl 2-propyl-3-cyclohexylmaleate, dipropyl 2,3-dibutylmaleate, dipropyl 2-butyl-3-pentylmaleate, dipropyl 2-butyl-3-hexylmaleate, dipropyl 2-butyl-3-octylmaleate, dipropyl 2-butyl-3-heptylmaleate, dipropyl 2-butyl-3-decylmaleate, dipropyl 2-butyl-3-isopropylmaleate, dipropyl 2-butyl-3-isobutylmaleate, dipropyl 2-butyl-3-neopentylmaleate, dipropyl 2-butyl-3-cyclopentylmaleate, dipropyl 2-butyl-3-cyclohexylmaleate, dipropyl 2,3-dipentylmaleate, dipropyl 2-pentyl-3-hexylmaleate, dipropyl 2-pentyl-3-octylmaleate, dipropyl 2-pentyl-3-heptylmaleate, dipropyl 2-pentyl-3-decylmaleate, dipropyl 2-pentyl-3-isopropylmaleate, dipropyl 2-pentyl-3-isobutylmaleate, dipropyl 2-pentyl-3-neopentylmaleate, dipropyl 2-pentyl-3-cyclopentylmaleate, dipropyl 2-pentyl-3-cyclohexylmaleate, dipropyl 2,3-dihexylmaleate, dipropyl 2-hexyl-3-octylmaleate, dipropyl 2-hexyl-3-heptylmaleate, dipropyl 2-hexyl-3-decylmaleate, dipropyl 2-hexyl-3-isopropylmaleate, dipropyl 2-hexyl-3-isobutylmaleate, dipropyl 2-hexyl-3-neopentylmaleate, dipropyl 2-hexyl-3-cyclopentylmaleate, dipropyl 2-hexyl-3-cyclohexylmaleate, dipropyl 2,3-dioctylmaleate, dipropyl 2-octyl-3-heptylmaleate, dipropyl 2-octyl-3-decylmaleate, dipropyl 2-octyl-3-isopropylmaleate, dipropyl 2-octyl-3-isobutylmaleate, dipropyl 2-octyl-3-neopentylmaleate, dipropyl 2-octyl-3-cyclopentylmaleate, dipropyl 2-octyl-3-cyclohexylmaleate, dipropyl 2,3-didecyllmaleate, dipropyl 2-decyl-3-isopropylmaleate, dipropyl 2-decyl-3-isobutylmaleate, dipropyl 2-decyl-3-neopentylmaleate, dipropyl 2-decyl-3-cyclopentylmaleate, dipropyl 2-decyl-3-cyclohexylmaleate, dipropyl 2,3-diisopropylmaleate, dipropyl 2-isopropyl-3-isobutylmaleate, dipropyl 2-isopropyl-3-neopentylmaleate, dipropyl 2-isopropyl-3-cyclopentylmaleate, dipropyl 2-isopropyl-3-cyclohexylmaleate, dipropyl 2,3-diisobutylmaleate, dipropyl 2-isobutyl-3-neopentylmaleate, dipropyl 2-isobutyl-3-cyclopentylmaleate, dipropyl 2-isobutyl-3-cyclohexylmaleate, dipropyl 2,3-dineopentylmaleate, dipropyl 2-neopentyl-3-cyclopentylmaleate, dipropyl 2-neopentyl-3-cyclohexylmaleate, dipropyl 2,3-dicyclopentylmaleate, dipropyl 2-cyclopentyl-3-cyclohexylmaleate, dipropyl 2,3-dicyclohexylmaleate, dibutyl 2,3-dimethylmaleate, dibutyl 2-methyl-3-ethylmaleate, dibutyl 2-methyl-3-propylmaleate, dibutyl 2-methyl-3-butylmaleate, dibutyl 2-methyl-3-pentylmaleate, dibutyl 2-methyl-3-hexylmaleate, dibutyl 2-methyl-3-octylmaleate, dibutyl 2-methyl-3-heptylmaleate, dibutyl 2-methyl-3-decylmaleate, dibutyl 2-methyl-3-isopropylmaleate, dibutyl 2-methyl-3-isobutylmaleate, dibutyl 2-methyl-3-neopentylmaleate, dibutyl 2-methyl-3-cyclopentylmaleate, dibutyl 2-methyl-3-cyclohexylmaleate, dibutyl 2,3-diethylmaleate, dibutyl 2-ethyl-3-propylmaleate, dibutyl 2-ethyl-3-butylmaleate, dibutyl 2-ethyl-3-pentylmaleate, dibutyl 2-ethyl-3-hexylmaleate, dibutyl 2-ethyl-3-octylmaleate, dibutyl 2-ethyl-3-heptylmaleate, dibutyl 2-ethyl-3-decylmaleate, dibutyl 2-ethyl-3-isopropylmaleate, dibutyl 2-ethyl-3-isobutylmaleate, dibutyl 2-ethyl-3-neopentylmaleate, dibutyl 2-ethyl-3-cyclopentylmaleate, dibutyl 2-ethyl-3-cyclohexylmaleate, dibutyl 2,3-dipropylmaleate, dibutyl 2-propyl-3-butylmaleate, dibutyl 2-propyl-3-pentylmaleate, dibutyl 2-propyl-3-hexylmaleate, dibutyl 2-propyl-3-octylmaleate, dibutyl 2-propyl-3-heptylmaleate, dibutyl 2-propyl-3-decylmaleate, dibutyl 2-propyl-3-isopropylmaleate, dibutyl 2-propyl-3-isobutylmaleate, dibutyl 2-propyl-3-neopentylmaleate, dibutyl 2-propyl-3-cyclopentylmaleate, dibutyl 2-propyl-3-cyclohexylmaleate, dibutyl 2,3-dibutylmaleate, dibutyl 2-butyl-3-pentylmaleate, dibutyl 2-butyl-3-hexylmaleate, dibutyl 2-butyl-3-octylmaleate, dibutyl 2-butyl-3-heptylmaleate, dibutyl 2-butyl-3-decylmaleate, dibutyl 2-butyl-3-isopropylmaleate, dibutyl 2-butyl-3-isobutylmaleate, dibutyl 2-butyl-3-neopentylmaleate, dibutyl 2-butyl-3-cyclopentylmaleate, dibutyl 2-butyl-3-cyclohexylmaleate, dibutyl 2,3-dipentylmaleate, dibutyl 2-pentyl-3-hexylmaleate, dibutyl 2-pentyl-3-octylmaleate, dibutyl 2-pentyl-3-heptylmaleate, dibutyl 2-pentyl-3-decylmaleate, dibutyl 2-pentyl-3-isopropylmaleate, dibutyl 2-pentyl-3-isobutylmaleate, dibutyl 2-pentyl-3-neopentylmaleate, dibutyl 2-pentyl-3-cyclopentylmaleate, dibutyl 2-pentyl-3-cyclohexylmaleate, dibutyl 2,3-dihexylmaleate, dibutyl 2-hexyl-3-octylmaleate, dibutyl 2-hexyl-3-heptylmaleate, dibutyl 2-hexyl-3-decylmaleate, dibutyl 2-hexyl-3-isopropylmaleate, dibutyl 2-hexyl-3-isobutylmaleate, dibutyl 2-hexyl-3-neopentylmaleate, dibutyl 2-hexyl-3-cyclopentylmaleate, dibutyl 2-hexyl-3-cyclohexylmaleate, dibutyl 2,3-dioctylmaleate, dibutyl 2-octyl-3-heptylmaleate, dibutyl 2-octyl-3-decylmaleate, dibutyl 2-octyl-3-isopropylmaleate, dibutyl 2-octyl-3-isobutylmaleate, dibutyl 2-octyl-3-neopentylmaleate, dibutyl 2-octyl-3-cyclopentylmaleate, dibutyl 2-octyl-3-cyclohexylmaleate, dibutyl 2,3-didecyllmaleate, dibutyl 2-decyl-3-isopropylmaleate, dibutyl 2-decyl-3-isobutylmaleate, dibutyl 2-decyl-3-neopentylmaleate, dibutyl 2-decyl-3-cyclopentylmaleate, dibutyl 2-decyl-3-cyclohexylmaleate, dibutyl 2,3-diisopropylmaleate, dibutyl 2-isopropyl-3-isobutylmaleate, dibutyl 2-isopropyl-3-neopentylmaleate, dibutyl 2-isopropyl-3-cyclopentylmaleate, dibutyl 2-isopropyl-3-cyclohexylmaleate, dibutyl 2,3-diisobutylmaleate, dibutyl 2-isobutyl-3-neopentylmaleate, dibutyl 2-isobutyl-3-cyclopentylmaleate, dibutyl 2-isobutyl-3-cyclohexylmaleate, dibutyl 2,3-dineopentylmaleate, dibutyl 2-neopentyl-3-cyclopentylmaleate, dibutyl 2-neopentyl-3-cyclohexylmaleate, dibutyl 2,3-dicyclopentylmaleate, dibutyl 2-cyclopentyl-3-cyclohexylmaleate, dibutyl 2,3-dicyclohexylmaleate, dioctyl 2,3-dimethylmaleate, dioctyl 2-methyl-3-ethylmaleate, dioctyl 2-methyl-3-propylmaleate, dioctyl 2-methyl-3-butylmaleate, dioctyl 2-methyl-3-pentylmaleate, dioctyl 2-methyl-3-hexylmaleate, dioctyl 2-methyl-3-octylmaleate, dioctyl 2-methyl-3-heptylmaleate, dioctyl 2-methyl-3-decylmaleate, dioctyl 2-methyl-3-isopropylmaleate, dioctyl 2-methyl-3-isobutylmaleate, dioctyl 2-methyl-3-neopentylmaleate, dioctyl 2-methyl-3-cyclopentylmaleate, dioctyl 2-methyl-3-cyclohexylmaleate, dioctyl 2,3-diethylmaleate, dioctyl 2-ethyl-3-propylmaleate, dioctyl 2-ethyl-3-butylmaleate, dioctyl 2-ethyl-3-pentylmaleate, dioctyl 2-ethyl-3-hexylmaleate, dioctyl 2-ethyl-3-octylmaleate, dioctyl 2-ethyl-3-heptylmaleate, dioctyl 2-ethyl-3-decylmaleate, dioctyl 2-ethyl-3-isopropylmaleate, dioctyl 2-ethyl-3-isobutylmaleate, dioctyl 2-ethyl-3-neopentylmaleate, dioctyl 2-ethyl-3-cyclopentylmaleate, dioctyl 2-ethyl-3-cyclohexylmaleate, dioctyl 2,3-dipropylmaleate, dioctyl 2-propyl-3-butylmaleate, dioctyl 2-propyl-3-pentylmaleate, dioctyl 2-propyl-3-hexylmaleate, dioctyl 2-propyl-3-octylmaleate, dioctyl 2-propyl-3-heptylmaleate, dioctyl 2-propyl-3-decylmaleate, dioctyl 2-propyl-3-isopropylmaleate, dioctyl 2-propyl-3-isobutylmaleate, dioctyl 2-propyl-3-neopentylmaleate, dioctyl 2-propyl-3-cyclopentylmaleate, dioctyl 2-propyl-3-cyclohexylmaleate, dioctyl 2,3-dibutylmaleate, dioctyl 2-butyl-3-pentylmaleate, dioctyl 2-butyl-3-hexylmaleate, dioctyl 2-butyl-3-octylmaleate, dioctyl 2-butyl-3-heptylmaleate, dioctyl 2-butyl-3-decylmaleate, dioctyl 2-butyl-3-isopropylmaleate, dioctyl 2-butyl-3-isobutylmaleate, dioctyl 2-butyl-3-neopentylmaleate, dioctyl 2-butyl-3-cyclopentylmaleate, dioctyl 2-butyl-3-cyclohexylmaleate, dioctyl 2,3-dipentylmaleate, dioctyl 2-pentyl-3-hexylmaleate, dioctyl 2-pentyl-3-octylmaleate, dioctyl 2-pentyl-3-heptylmaleate, dioctyl 2-pentyl-3-decylmaleate, dioctyl 2-pentyl-3-isopropylmaleate, dioctyl 2-pentyl-3-isobutylmaleate, dioctyl 2-pentyl-3-neopentylmaleate, dioctyl 2-pentyl-3-cyclopentylmaleate, dioctyl 2-pentyl-3-cyclohexylmaleate, dioctyl 2,3-dihexylmaleate, dioctyl 2-hexyl-3-octylmaleate, dioctyl 2-hexyl-3-heptylmaleate, dioctyl 2-hexyl-3-decylmaleate, dioctyl 2-hexyl-3-isopropylmaleate, dioctyl 2-hexyl-3-isobutylmaleate, dioctyl 2-hexyl-3-neopentylmaleate, dioctyl 2-hexyl-3-cyclopentylmaleate, dioctyl 2-hexyl-3-cyclohexylmaleate, dioctyl 2,3-dioctylmaleate, dioctyl 2-octyl-3-heptylmaleate, dioctyl 2-octyl-3-decylmaleate, dioctyl 2-octyl-3-isopropylmaleate, dioctyl 2-octyl-3-isobutylmaleate, dioctyl 2-octyl-3-neopentylmaleate, dioctyl 2-octyl-3-cyclopentylmaleate, dioctyl 2-octyl-3-cyclohexylmaleate, dioctyl 2,3-didecyllmaleate, dioctyl 2-decyl-3-isopropylmaleate, dioctyl 2-decyl-3-isobutylmaleate, dioctyl 2-decyl-3-neopentylmaleate, dioctyl 2-decyl-3-cyclopentylmaleate, dioctyl 2-decyl-3-cyclohexylmaleate, dioctyl 2,3-diisopropylmaleate, dioctyl 2-isopropyl-3-isobutylmaleate, dioctyl 2-isopropyl-3-neopentylmaleate, dioctyl 2-isopropyl-3-cyclopentylmaleate, dioctyl 2-isopropyl-3-cyclohexylmaleate, dioctyl 2,3-diisobutylmaleate, dioctyl 2-isobutyl-3-neopentylmaleate, dioctyl 2-isobutyl-3-cyclopentylmaleate, dioctyl 2-isobutyl-3-cyclohexylmaleate, dioctyl 2,3-dineopentylmaleate, dioctyl 2-neopentyl-3-cyclopentylmaleate, dioctyl 2-neopentyl-3-cyclohexylmaleate, dioctyl 2,3-dicyclopentylmaleate, dioctyl 2-cyclopentyl-3-cyclohexylmaleate, dioctyl 2,3-dicyclohexylmaleate, diisobutyl 2,3-dimethylmaleate, diisobutyl 2-methyl-3-ethylmaleate, diisobutyl 2-methyl-3-propylmaleate, diisobutyl 2-methyl-3-butylmaleate, diisobutyl 2-methyl-3-pentylmaleate, diisobutyl 2-methyl-3-hexylmaleate, diisobutyl 2-methyl-3-octylmaleate, diisobutyl 2-methyl-3-heptylmaleate, diisobutyl 2-methyl-3-decylmaleate, diisobutyl 2-methyl-3-isopropylmaleate, diisobutyl 2-methyl-3-isobutylmaleate, diisobutyl 2-methyl-3-neopentylmaleate, diisobutyl 2-methyl-3-cyclopentylmaleate, diisobutyl 2-methyl-3-cyclohexylmaleate, diisobutyl 2,3-diethylmaleate, diisobutyl 2-ethyl-3-propylmaleate, diisobutyl 2-ethyl-3-butylmaleate, diisobutyl 2-ethyl-3-pentylmaleate, diisobutyl 2-ethyl-3-hexylmaleate, diisobutyl 2-ethyl-3-octylmaleate, diisobutyl 2-ethyl-3-heptylmaleate, diisobutyl 2-ethyl-3-decylmaleate, diisobutyl 2-ethyl-3-isopropylmaleate, diisobutyl 2-ethyl-3-isobutylmaleate, diisobutyl 2-ethyl-3-neopentylmaleate, diisobutyl 2-ethyl-3-cyclopentylmaleate, diisobutyl 2-ethyl-3-cyclohexylmaleate, diisobutyl 2,3-dipropylmaleate, diisobutyl 2-propyl-3-butylmaleate, diisobutyl 2-propyl-3-pentylmaleate, diisobutyl 2-propyl-3-hexylmaleate, diisobutyl 2-propyl-3-octylmaleate, diisobutyl 2-propyl-3-heptylmaleate, diisobutyl 2-propyl-3-decylmaleate, diisobutyl 2-propyl-3-isopropylmaleate, diisobutyl 2-propyl-3-isobutylmaleate, diisobutyl 2-propyl-3-neopentylmaleate, diisobutyl 2-propyl-3-cyclopentylmaleate, diisobutyl 2-propyl-3-cyclohexylmaleate, diisobutyl 2,3-dibutylmaleate, diisobutyl 2-butyl-3-pentylmaleate, diisobutyl 2-butyl-3-hexylmaleate, diisobutyl 2-butyl-3-octylmaleate, diisobutyl 2-butyl-3-heptylmaleate, diisobutyl 2-butyl-3-decylmaleate, diisobutyl 2-butyl-3-isopropylmaleate, diisobutyl 2-butyl-3-isobutylmaleate, diisobutyl 2-butyl-3-neopentylmaleate, diisobutyl 2-butyl-3-cyclopentylmaleate, diisobutyl 2-butyl-3-cyclohexylmaleate, diisobutyl 2,3-dipentylmaleate, diisobutyl 2-pentyl-3-hexylmaleate, diisobutyl 2-pentyl-3-octylmaleate, diisobutyl 2-pentyl-3-heptylmaleate, diisobutyl 2-pentyl-3-decylmaleate, diisobutyl 2-pentyl-3-isopropylmaleate, diisobutyl 2-pentyl-3-isobutylmaleate, diisobutyl 2-pentyl-3-neopentylmaleate, diisobutyl 2-pentyl-3-cyclopentylmaleate, diisobutyl 2-pentyl-3-cyclohexylmaleate, diisobutyl 2,3-dihexylmaleate, diisobutyl 2-hexyl-3-octylmaleate, diisobutyl 2-hexyl-3-heptylmaleate, diisobutyl 2-hexyl-3-decylmaleate, diisobutyl 2-hexyl-3-isopropylmaleate, diisobutyl 2-hexyl-3-diisobutylmaleate, diisobutyl 2-hexyl-3-neopentylmaleate, diisobutyl 2-hexyl-3-cyclopentylmaleate, diisobutyl 2-hexyl-3-cyclohexylmaleate, diisobutyl 2,3-dioctylmaleate, diisobutyl 2-octyl-3-heptylmaleate, diisobutyl 2-octyl-3-decylmaleate, diisobutyl 2-octyl-3-isopropylmaleate, diisobutyl 2-octyl-3-isobutylmaleate, diisobutyl 2-octyl-3-neopentylmaleate, diisobutyl 2-octyl-3-cyclopentylmaleate, diisobutyl 2-octyl-3-cyclohexylmaleate, diisobutyl 2,3-didecyllmaleate, diisobutyl 2-decyl-3-isopropylmaleate, diisobutyl 2-decyl-3-isobutylmaleate, diisobutyl 2-decyl-3-neopentylmaleate, diisobutyl 2-decyl-3-cyclopentylmaleate, diisobutyl 2-decyl-3-cyclohexylmaleate, diisobutyl 2,3-diisopropylmaleate, diisobutyl 2-isopropyl-3-isobutylmaleate, diisobutyl 2-isopropyl-3-neopentylmaleate, diisobutyl 2-isopropyl-3-cyclopentylmaleate, diisobutyl 2-isopropyl-3-cyclohexylmaleate, diisobutyl 2,3-diisobutylmaleate, diisobutyl 2-isobutyl-3-neopentylmaleate, diisobutyl 2-isobutyl-3-cyclopentylmaleate, diisobutyl 2-isobutyl-3-cyclohexylmaleate, diisobutyl 2,3-dineopentylmaleate, diisobutyl 2-neopentyl-3-cyclopentylmaleate, diisobutyl 2-neopentyl-3-cyclohexylmaleate, diisobutyl 2,3-dicyclopentylmaleate, diisobutyl 2-cyclopentyl-3-cyclohexylmaleate, diisobutyl 2,3-dicyclohexylmaleate or the like.

The above step (2) is preferably carried out by while gradually increasing the temperature of the product resulted from the step (1) to the range of 60-150° C., adding an internal electron donor thereto and allowing for them to react for 1-3 hours. When the temperature is less than 60° C. or the reaction time is less than 1 hour, the reaction can be hardly completed, and when the temperature is more than 150° C. or the reaction time is more than 3 hours, a side-reaction which may occur may lower the polymerization activity or stereospecificity of the resulted catalyst.

The temperature and the number of addition of the internal electron donor, as long as it is added during the temperature increasing process, are not specifically limited, and the total amount of the internal electron donor used is preferably 0.1-1.0 mole based on 1 mole of dialkoxymagnesium. When the amount is out of said range, the polymerization activity or stereospecificity of the resulted catalyst may be decreased disadvantageously.

The step (3) of the catalyst preparation process according to the present invention is a process in which the product resulted from the above step (2) is secondarily reacted with titanium halide at the temperature range of 60-150° C. The examples of titanium halide used in this step may include titanium halide having the above general formula (I).

The reactions at each step of the above solid catalyst preparation method are preferably carried out in a reactor equipped with a stirrer from which moisture was sufficiently removed, under nitrogen atmosphere.

The solid catalyst prepared by the above method of the present invention is formed by comprising magnesium, titanium, halogen and an internal electron donor, and preferably comprising magnesium 5-40 wt %, titanium 0.5-10 wt %, halogen 50-85 wt % and an internal electron donor 2.5-30 wt % in terms of the catalyst activity.

The solid catalyst of the present invention may be suitably used in polypropylene preparation, and the method for polypropylene preparation using the solid catalyst obtained by the present invention comprises polymerization of propylene or co-polymerization of propylene with other alpha-olefins at the presence of the solid catalyst, a cocatalyst and an external electron donor.

The solid catalyst may be prepolymerized with ethylene or alpha-olefins before being used as a component of a polymerization reaction.

The prepolymerization reaction may be carried out at a sufficiently low temperature under the pressure of ethylene or alpha-olefin, at the presence of hydrocarbon solvent such as hexane, said catalyst component and organoaluminum compound such as triethylaluminum. The prepolymerization by which catalyst particles are surrounded by polymers so as to maintain the catalyst shape, helps improve the polymer morphology after polymerization. The weight ratio of polymer:catalyst after completion of prepolymerization is preferably about 0.1˜20:1.

As a cocatalyst component for the polypropylene preparation method of the present invention, organometallic compounds belonging to Group II or III of the Periodic table of element may be used, for example alkylaluminum compounds are preferably used. The alkylaluminum compounds are represented by the following formula (III):

AlR₃ (III)

wherein, R is a C1˜6 alkyl group.

As for the specific examples of such alkylaluminum compounds, trimethylaluminum, triethylaluminum, tripropylaluminum, tributylaluminum, triisobutylaluminum and trioctylaluminum or the like may be mentioned.

The ratio of the cocatalyst to the solid catalyst component may be varied depending on a polymerization method used, however the molar ratio of the metal element of the cocatalyst to the titanium element in the solid catalyst component is preferably the range of 1˜1000 and more preferably the range of 10˜300. When the molar ratio of the metal element, for example such as aluminum in the cocatalyst to the titanium element in the solid catalyst component is out of said range of 1˜1000, the polymerization activity is significantly degraded, disadvantageously.

As for the external electron donor used in the method for preparing polypropylene according to the present invention, one type of alkoxy silane compounds represented by the following formula (IV) may be used:

R¹ₘR²ₙSi(OR³)₍₄₋ₘ₋ₙ₎ (IV)

wherein, R¹ and R², which may be same or different, are independently linear or branched or cyclic C1-12 alkyl or aryl group; R³ is linear or branched C1-6 alkyl group; m and n are independently 0 or 1; and m+n is 1 or 2.

Specific examples of the external electron donor include the following compounds, and it may be used alone or as a mixture of one or more: n-propyltrimethoxysilane, di-n-propyldimethoxysilane, isopropyltrimethoxysilane, diisopropyldimethoxysilane, n-butyltrimethoxysilane, di-n-butyldimethoxysilane, isobutyltrimethoxysilane, diisobutyldimethoxysilane, tert-butyltrimethoxysilane, di-tert-butyldimethoxysilane, n-pentyltrimethoxysilane, di-n-pentyldimethoxysilane, cyclopentyltrimethoxysilane, dicyclopentyldimethoxysilane, cyclopentylmethyldimethoxysilane, cyclopentylethyldimethoxysilane, cyclopentylpropyldimethoxysilane, cyclohexyltrimethoxysilane, dicyclohexyldimethoxysilane, cyclohexylmethyldimethoxysilane, cyclohexylethyldimethoxysilane, cyclohexylpropyldimethoxysilane, cycloheptyltrimethoxysilane, dicycloheptyldimethoxysilane, cycloheptylmethyldimethoxysilane, cycloheptylethyldimethoxysilane, cycloheptylpropyldimethoxysilane, phenyltrimethoxysilane, diphenyldimethoxysilane, phenylmethyldimethoxysilane, phenylethyldimethoxysilane, phenylpropyldimethoxysilane, n-propyltriethoxysilane, di-n-propyldiethylxysilane, isopropyltriethylxysilane, diisopropyldiethylxysilane, n-butyltriethylxysilane, di-n-butyldiethylxysilane, isobutyltriethylxysilane, diisobutyldiethylxysilane, tert-butyltriethylxysilane, di-tert-butyldiethylxysilane, n-pentyltriethylxysilane, di-n-pentyldiethylxysilane, cyclopentyltriethylxysilane, dicyclopentyldiethylxysilane, cyclopentylmethyldiethylxysilane, cyclopentylethyldiethylxysilane, cyclopentylpropyldiethylxysilane, cyclohexyltriethylxysilane, dicyclohexyldiethylxysilane, cyclohexylmethyldiethylxysilane, cyclohexylethyldiethylxysilane, cyclohexylpropyldiethylxysilane, cycloheptyltriethylxysilane, dicycloheptyldiethylxysilane, cycloheptylmethyldiethylxysilane, cycloheptylethyldiethylxysilane, cycloheptylpropyldiethylxysilane, phenyltriethylxysilane, di-phenyldiethylxysilane, phenylmethyldiethylxysilane, phenylethyldiethylxysilane, phenylpropyldiethylxysilane or the like. The amount of external electron donor may be slightly varied depending on the polymerization method applied thereto, however the molar ratio of the silicon atom in the external electron donor to the titanium atom in the catalyst component is preferably in the range of 0.1-500 and more preferably 1-100. When the molar ratio of the silicon atom in the external electron donor to the titanium atom in the catalyst component is less than 0.1, stereoregularity of the propylene polymer is significantly lowered, disadvantageously, and when it is more than 500, polymerization activity of the catalyst is significantly decreased.

During the propylene polymerization or copolymerization reaction, the polymerization temperature is preferably 20-120° C. When the polymerization temperature is less than 20° C., the polymerization reaction cannot sufficiently proceed, and when it is more than 120° C., the activity is considerably lowered and the physical properties of the resulted polymers is degraded, disadvantageously.

### EXAMPLES

Hereinafter, the present invention is further described through the following example, in detail. However, it should be understood that the examples are only provided on illustrative purposes without any intention to limit the scope of the present invention.

### Example 1

### 1. Preparation of Solid Catalyst

To a 1 L-volume glass reactor of which atmosphere was sufficiently substituted by nitrogen, equipped with a stirrer, 150 ml of toluene and 20 g of spherical-shaped diethoxymagnesium having an average particle size of 20 μm, particle distribution index of 0.86, bulk density of 0.35 g/cc were added, then 40 ml of titanium tetrachloride diluted in 60 ml toluene was added thereto over 1 hour while maintaining the temperature at 10° C., and then thereto 7.0 g of dibutyl 2,3-diisopropylmaleate was added while increasing the reactor temperature to 110° C. After maintaining the temperature at 110° C. for 2 hours and lowering to 90° C., stirring was halted, the supernatant was removed, and the resultant was washed once with additional 200 ml toluene. Thereto, 150 ml toluene and 50 ml titanium tetrachloride were added, and the temperature was raised to 110° C. and maintained for 2 hours for aging. After completion of the aging process, the mixed slurry was washed twice with 200 ml toluene for each washing, and then washed 5 times at 40° C. with 200 ml n-hexane for each washing, thereby obtaining a pale yellow solid catalyst component. The obtained catalyst component was dried for 18 hours under a nitrogen stream, and the titanium content in the resulted solid catalyst component was 2.8 wt %.

### 2. Polypropylene Polymerization

Into a 4 L-volume high-pressure stainless reactor, 10 mg of thus obtained solid catalyst, 6.6 mmol of triethylaluminum and 0.66 mmol of cyclohexylmethyldimethoxysilane were added. Next, 1000 ml of hydrogen and 2.4 L of liquid propylene were added in this order and polymerization was carried out at an elevated temperature of 70° C. After 2 hours from the start of polymerization, the remaining propylene inside the reactor was completely removed by opening the valve, while lowering the reactor temperature to room temperature. Analysis of thus resulted polymer was carried out and the results were represented in Table 1.

The catalyst activity, stereoregularity, melt flow rate, molecular weight distribution and the like were determined by the following method.
\textcircled{1} Catalyst activity(kg-PP/g-cat)=the amount of polymers produced (kg)÷the amount of catalyst used(g)
\textcircled{2} Stereregularity (X.I.): the amount of insolubles crystallized and precipitated in mixed xylene solvent(wt %)
\textcircled{3} Melt Flow Rate (MFR): a value measured by ASTM1238 (230° C. 2.16 kg)
\textcircled{4} Molecular weight distribution(P.I.): a modulus separation value was measured by using parallel plate rheometer at 200° C. and then calculated through the following equality:

P.I.=54.6×(modulus separation)^{-1.76}

### Example 2

A catalyst was prepared according to the method described in Example 1 except that 7.6 g of dibutyl 2,3-diisobutylmaleate was used instead of 7.0 g of dibutyl 2,3-diisopropylmaleate in the preparation of solid catalyst. The titanium content of the resulted solid catalyst component was 2.9 wt %. Next, propylene polymerization was carried out by the same method as in Example 1, and the result was represented in Table 1.

### Example 3

A catalyst was prepared according to the method described in Example except that 5.7 g of diethyl 2,3-diisopropylmaleate was used instead of 7.0 g of dibutyl 2,3-diisopropylmaleate in the preparation of solid catalyst. The titanium content of the resulted solid catalyst component was 2.6 wt %. Next, propylene polymerization was carried out by the same method as in Example 1, and the result was represented in Table 1.

### Example 4

A catalyst was prepared according to the method described in Example 1 except that 6.4 g of diethyl 2,3-diisobutylmaleate was used instead of 7.0 g of dibutyl 2,3-diisopropylmaleate in the preparation of solid catalyst. The titanium content of the resulted solid catalyst component was 2.8 wt %. Next, propylene polymerization was carried out by the same method as in Example 1, and the result was represented in Table 1.

### Comparative Example 1

### 1. Preparation of Solid Catalyst

To a 1 L-volume glass reactor of which atmosphere was sufficiently substituted by nitrogen, equipped with a stirrer, 150 ml of toluene, 12 ml of tetrahydrofuran, 20 ml of butanol and 21 g of magnesium chloride were added, and the temperature was raised to 110° C. and maintained for 1 hour, thereby obtaining a homogenous solution. The resulted solution was cooled to 15° C., then added with 25 ml titanium tetrachloride, and then, the reactor temperature was raised to 60° C. over 1 hour. After aging for 10 minutes, the mixture was stood still for 15 minute so as to precipitate the carriers, and the supernatant was removed. To the slurry remained in the reactor, 200 ml toluene was added, and stirring, allowing to stand still and removal of the supernatant was carried out twice for washing. To the resulted slurry, 150 ml toluene was added, then 25 ml titanium tetrachloride diluted in 50 ml toluene was further added at 15° C. over 1 hour, and the reactor temperature was elevated to 30° C. at the speed of 0.5° C. per minute. The reaction mixture was maintained at 30° C. for 1 hour, 7.5 ml of diisobutylphthalate was added, and then its temperature was elevated to 110° C. at the speed of 0.5° C. per minute.

After maintaining the temperature at 110° C. for 1 hour and lowering to 90° C., stirring was halted, the supernatant was removed, and the resultant was washed once with additional 200 ml toluene in the same way. Thereto, 150 ml toluene and 50 ml titanium tetrachloride were added, and the temperature was raised to 110° C. and maintained for 1 hour for aging. After completion of the aging process, the mixed slurry was washed twice with 200 ml toluene for each washing, and then washed 5 times at 40° C. with 200 ml n-hexane for each washing, thereby obtaining a pale yellow solid catalyst component. The obtained catalyst component was dried for 18 hours under a nitrogen stream, and the titanium content in the resulted solid catalyst component was 3.3 wt %.

### 2. Polypropylene Polymerization

Polymerization was carried out according to the method described in Example 1 except using the above-obtained solid catalyst 10 mg, and the result was represented in Table 1.

### Comparative Example 2

A catalyst was prepared according to the method described in Example 1 except that 5.1 g of dibutylmaleate was used instead of 7.0 g of dibutyl 2,3-diisopropylmaleate in the preparation of solid catalyst. The titanium content of the resulted solid catalyst component was 3.3 wt %. Next, propylene polymerization was carried out by the same method as in Example 1, and the result was represented in Table 1.

### Comparative Example 3

A catalyst was prepared according to the method described in Example 1 except that 6.1 g of dibutylisopropylmaleate was used instead of 7.0 g of dibutyl 2,3-diisopropylmaleate in the preparation of solid catalyst. The titanium content of the resulted solid catalyst component was 3.4 wt %. Next, propylene polymerization was carried out by the same method as in Example 1, and the result was represented in Table 1.

TABLE 1

| | | | Melt flow | Molecular |
|---|---|---|---|---|
| | Activity | | rate | weight |
| | (kg-PP/g- | Stereoregularity | (MFR, g/ | distribution |
| | Cat) | (X.I., wt. %) | 10 min) | (P.I.) |
| Example 1 | 38 | 98.7 | 0.8 | 6.0 |
| Example 2 | 45 | 98.5 | 1.1 | 5.8 |
| Example 3 | 34 | 98.9 | 1.0 | 6.4 |
| Example 4 | 39 | 98.6 | 0.9 | 6.2 |
| Comp. | 26 | 97.3 | 5.6 | 4.8 |
| example 1 | | | | |
| Comp. | 25 | 97.5 | 4.7 | 4.1 |
| example 2 | | | | |
| Comp. | 47 | 96.8 | 4.3 | 4.0 |
| example 3 | | | | |

As seen from the above Table 1, Examples 1-4 according to the present invention have excellent stereoregularity and a wide molecular molecular weight distribution, to the contrary, Comparative examples 1-3 show poor stereoregularity and a narrow molecular weight distribution.

### INDUSTRIAL AVAILABILITY

By using the solid catalyst for propylene polymerization according to the present invention and a method for preparing polypropylene using the same, it is possible to prepare polypropylene having excellent stereoregularity and a wide molecular weight distribution.

1. A solid catalyst for propylene polymerization, which comprises titanium, magnesium, halogen and maleate compounds represented by the following formula (II) as an internal electron donor: 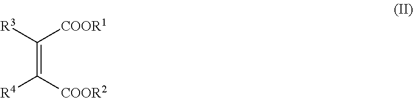
wherein, R¹, R², R³ and R⁴, which may be same or different from each other, are independently linear, branched or cyclic C1-20 alkyl, alkenyl, aryl, arylalkyl or alkylaryl group.

2. The solid catalyst for propylene polymerization according to claim 1, comprising magnesium 5-40 wt %, titanium 0.5-10 wt %, halogen 50-85 wt % and the internal electron donor 2.5-30 wt %.

3. Method for preparing polypropylene comprising polymerizing propylene or copolymerizing propylene with other alpha-olefins, in the presence of a solid catalyst according to claim 1, AlR₃, wherein R is C1-6 alkyl group as a cocatalyst and R¹ₘR²ₙSi(OR³)₍₄₋ₘ₋ₙ₎, wherein R¹ and R², which are same or different, linear, branched or cyclic C1-12 alkyl or aryl group; R³ is linear or branched C1-6 alkyl group; m and n are 0 or 1, respectively, provided that m+n is 1 or 2, as an external electron donor.

4. Method for preparing polypropylene comprising polymerizing propylene or copolymerizing propylene with other alpha-olefins, in the presence of a solid catalyst according to claim 2, AlR₃, wherein R is C1-6 alkyl group as a cocatalyst and R¹ₘR²ₙSi(OR³)₍₄₋ₘ₋ₙ₎, wherein R¹ and R², which are same or different, linear, branched or cyclic C1-12 alkyl or aryl group; R³ is linear or branched C1-6 alkyl group; m and n are 0 or 1, respectively, provided that m+n is 1 or 2, as an external electron donor.
